(19) United States
(12) Patent Application Publication
(10) Pub. No.: US 2013/0028576 A1
(43) Pub. Date: Jan. 31, 2013

(54) REPRODUCTION CONTROL DEVICE AND REPRODUCTION CONTROL METHOD

(71) Applicants: Chikara Ushimaru, Akishima-shi (JP); Yasuhiro Morioka, Kawasaki-shi (JP)

(72) Inventors: Chikara Ushimaru, Akishima-shi (JP); Yasuhiro Morioka, Kawasaki-shi (JP)

(73) Assignee: KABUSHIKI KAISHA TOSHIBA, Tokyo (JP)

(21) Appl. No.: 13/489,391

(22) Filed: Jun. 5, 2012

(30) Foreign Application Priority Data
Jul. 29, 2011 (JP) 2011-167749
Feb. 29, 2012 (JP) 2012-044806

(51) Int. Cl. H04N 5/92

(52) U.S. Cl. 386/326; 386/E05.001

(57) ABSTRACT

One embodiment provides a reproduction control device including: a first receiving module configured to receive addresses of plural respective content data that correspond to each other in substance but are different from each other in usable functions and first function information indicating sets of usable functions of the plural respective content data; a second receiving module configured to receive second function information indicating functions supported by an external device; a selecting module configured to select a function to be used in playing back; and a sending module configured to determine content data that allow the external device to use the selected function according to the first and second function information, and to send an address of the determined content data to the external device.

CROSS-REFERENCE TO RELATED APPLICATION(S)

This application claims priorities from Japanese Patent Application No. 2011-167749 filed on Jul. 29, 2011 and Japanese Patent Application No. 2012-044806 filed on Feb. 29, 2012, the entire contents of which are incorporated herein by reference.

### FIELD

Embodiments described herein relate generally to a reproduction control device and a reproduction control method.

### BACKGROUND

Sometimes, home electronic devices such as a computer, a digital TV receiver and a hard disk recorder are connected to each other by a local area network so that contents such as videos and images are shared. For example, UPnP is used as a specification for mutual connections and operation of such electronic devices. A display device such as a digital TV receiver sends a storage device such as a recorder a request for transmission of a content stored in the storage device, according to a protocol of UPnP. A URI of the content is specified in the transmission request. The display device receives and plays back the content that is transmitted from the storage device.

When the storage device stores plural content data that correspond to each other in substance but allow use of different functions, it may be preferable to cause the display device to play back content data that allows use of a function that is desired by a user.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 illustrates a use form of a reproduction control device according to an embodiment.

FIG. 2 illustrates system configurations of the reproduction control device etc. according to the first embodiment.

FIG. 3 illustrates operations performed by the reproduction control device etc. according to the first embodiment.

FIG. 4 illustrates a content data list to be acquired by the reproduction control device according to the first embodiment.

FIG. 5 illustrates a database, generated by the reproduction control device accommodates according to the first embodiment, of pieces of information indicating functions that a display device.

FIGS. 6A and 6B illustrate pictures to be displayed by the reproduction control device according to the first embodiment.

FIG. 7 illustrates how the reproduction control device selects content data according to the first embodiment.

FIG. 8 illustrates system configurations of a reproduction control device etc. according to a second embodiment.

FIG. 9 illustrates a content data list to be acquired by the reproduction control device according to the embodiment.

FIG. 10 illustrates a database, generated by the reproduction control device according to the second embodiment, of pieces of decoding processing ability information of a display device.

FIG. 11 illustrates a setting picture to be displayed by the reproduction control device according to the second embodiment.

FIG. 12 illustrates operations performed by the reproduction control device etc. according to the second embodiment.

### DETAILED DESCRIPTION

In general, one embodiment provides a reproduction control device including: a first receiving module configured to receive addresses of plural respective content data that are stored in a storage device connected to a network and that correspond to each other in substance but are different from each other in usable functions and first function information indicating sets of usable functions of the plural respective content data; a second receiving module configured to receive second function information indicating functions supported by an external device; a selecting module configured to select a function to be used in playing back; and a sending module configured to determine whether there exists one or more content data that allow the external device to use the selected function among the plural content data according to the received first function information and the second function information, and to send an address of the determined one or more content data to the external device when it exists.

### First Embodiment

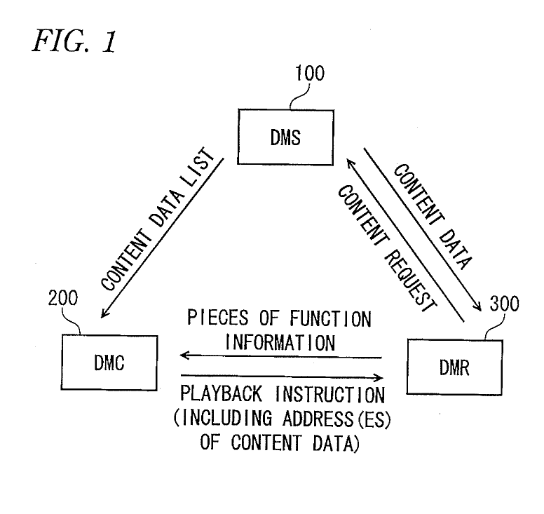

A first embodiment will be hereinafter described with reference to FIGS. 1-7. FIG. 1 illustrates a use form of a reproduction control device according to the embodiment. In the embodiment, the reproduction control device is implemented as a DMC 200. The DMC 200, a DMS 100, and a DMR 300 are connected to each other by a network.

Each of the DMS 100, DMC 200, and the DMR 300 has a UPnP function for recognizing the presence of each device on a network and controlling its functions. By utilizing the UPnP function, each of the DMS 100, DMC 200, and the DMR 300 function as home network devices as prescribed by DLNA (Digital Living Network Alliance) guidelines, for example.

The MDS 100, which is a storage device for storing contents, opens pieces of content information such as URIs and content names of contents stored therein to the network using the CDS (content directory service) of UPnP so that the DMC 200 can acquire the pieces of content information. The MDS 100 receives a content request (HTTP GET) from the DMR 300 and supplies the specified content to the DMR 300.

The DMC 200, which is such a device as a TV receiver or a computer capable of being manipulated by the user, controls such devices as the DMS 100 and the DMR 300 according to a user manipulation or the like. The DMC 200 acquires, by a Browse action, for example, pieces of content information that are opened to the network from the DMS 100 by the CDS and thereby acquires URIs of the contents. And, the DMS 200 causes the DMR 300 to set an acquired URI of a playback subject content by a SetAVTransportURI action of the AVT (audio/visual transport service) of UPnP which is installed in the DMR 300.

The DMS 100 may store plural content data that correspond to the same content (i.e., they are the same in substance) but are different from each other in the media format or the functions (seeking (possible/impossible), playback speeds of fast feed/rewind using a seek, etc.) that can be used during a playback. In this case, the DMC 200 sends URIs of the plural respective content data to the DMR 300. The seeking is processing of moving (jumping) a reproduction position to a prescribed position and is used in doing fast feed or rewind. For example, during a playback of video data, fast feed or rewind can be realized by successively performing a jump from a current reproduction position of the video data to a position that succeeds or precedes the current reproduction position by a prescribed time.

The DMR 300 is a display device such as a TV receiver or a monitor. When receiving a Play action of the AVT from the DMC 200 immediately after setting, by the DMC 200, of a URI of a content to be played back by the DMR 300, the DMR 300 sends a content request to the thus-set URI. When receiving content data that is sent from the DMS 200 in response to the content request, the DMR 300 decodes and displays the received content data. If receiving addresses of plural content data that correspond to each other in substance from the DMC 200, the DMR 300 selects, from these content data, content data that is suitable for the implementation (e.g., high-resolution content data is given higher priority) of the DMR 300.

The DMC 200 according to the embodiment acquires pieces of information indicating reproducible media formats and functions that the DMR 300 accommodates (seek methods, fast feed/rewind playback speeds that can be used in each seek method, manipulations that can be accepted, etc.). The DMC 200 acquires pieces of function information from, for example, CMS.SinkProtocolInfo and TransportPlaySpeed contained in AVT ServiceDescription that are sent from the DMR 300. CMS.SinkProtocolInfo can be acquired by sending a CMS.GetProtocolInfo command to the DMR 300. The DMC 200 can also acquire pieces of function information of the DMR 300 by sending the DMR 300 an AVT.GetCurrentTransportAction command while the DMR 300 is playing back a content and receiving pieces of information (including seek methods and fast feed/rewind playback speeds that can be used in each seek method) that are sent from the DMR 300 in response to the command.

The DMC 200 can receive taste information relating to functions that the user wants to use during a playback of a content. In instructing the DMR 300 to play back a content, if there are plural contents that are different from each other in the media format or the functions that the DMR 300 accommodates (seeking (possible/impossible), fast feed/rewind playback speeds that can be used in each seek method, etc.), the DMC 200 selects, from those contents, one or more contents that conform to user taste information (narrowing down). Then, the DMC 200 causes the DMR 300 to set the selected content(s) as playback subject(s).

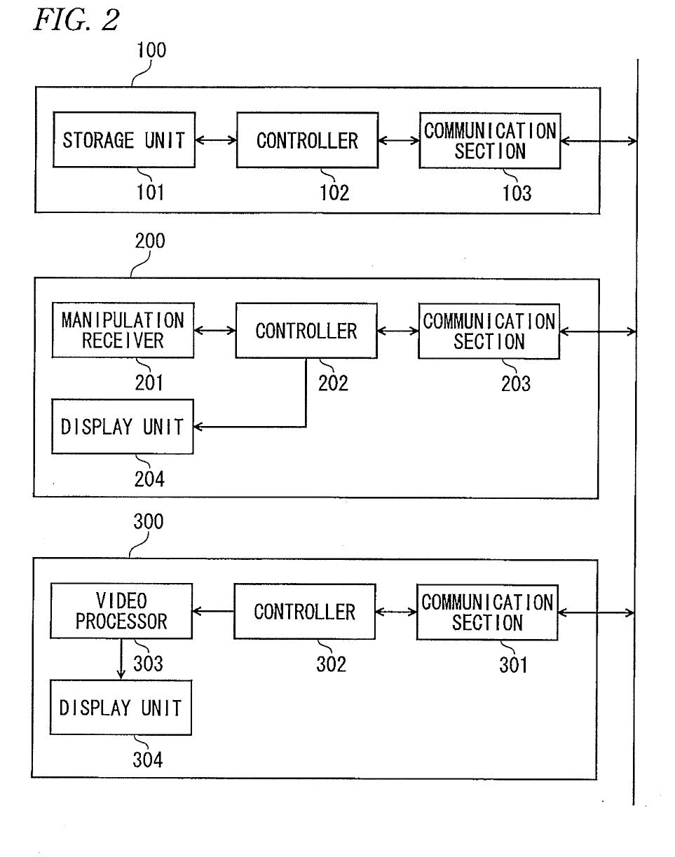

FIG. 2 illustrates system configurations of the DMS 100, the DMC 200, and the DMR 300.

The DMC 100 includes a storage unit 101, a controller 102, a communication section 103, etc.

The storage unit 101 stores content data such as video contents and photograph contents. The storage unit 101 may store plural content data corresponding to the same content. Examples of such plural content data are video content data of the same broadcast program that are different from each other in the media format, image quality, the usable functions (seek methods, playback speeds that can be used in each seek method, etc.). Examples of the usable functions are seeking which is performed during a playback and playback speeds that can be used in a seek.

The controller 102 assigns addresses to the respective content data stored in the storage unit 101 and generates a list in which media formats, resolutions, file sizes, and sets of usable functions (seek methods, playback speeds corresponding to each seek method, etc.) of the content data are correlated with the respective addresses and content names. The controller 102 opens the generated list to the network through the communication section 103 using the above-mentioned CDS of UPnP. When the communication section 103 receives, from the DMR 300, a content request in which an address of a content is specified, the controller 102 sends content data having the specified address to the DMR 300.

The DMC 200 includes a manipulation receiver 201, a controller 202, a communication section 203, a display unit 204, etc.

The manipulation receiver 201 receives a user manipulation that is performed on a remote controller, a pointing device such as a mouse, an operation panel provided on a main body cabinet of the DMC 200, etc. For example, the manipulation receiver 201 receives a manipulation for specifying a function desired by the user in playing back a content and a manipulation for selecting a content to be played back.

The controller 202 controls the individual units and sections of the DMC 200. The controller 202 acquires the list that is opened by the DMS 100. That is, the DMC 200 receives pieces of information indicating the content name, address, media format, resolution, file size, and usable functions (seek methods, seek playback speeds, etc.) of each content data stored in the DMS 100. As mentioned above, the content data stored in the DMS 100 may include plural content data that are different from each other in at least one of the media format, resolution, file size, and usable functions are correlated with the same content. That is, plural kinds of content data may exist for the same content having a certain content name.

The controller 202 generates a setting picture for setting a function that is desired by the user. The controller 202 displays the setting picture on the display unit 204 and sets user taste information according to a manipulation performed on the setting picture. And, the controller 202 generates a selection picture which allows the user to select a content to be played back, and sends a content playback instruction to the DMR 300 through the communication section 203 according to a manipulation performed on the selection picture.

The DMR 300 includes a communication section 301, a controller 302, a video processor 303, a display unit 304, etc.

The communication section 301 receives various commands and content data that are transmitted over the network.

The controller 302 performs processing that corresponds to a command received by the communication section 301. More specifically, when the communication section 301 receives a content address and a playback request from the DMC 200, the controller 302 sends a content request to the received address using the communication section 301. When the communication section 301 receives content data, the controller 302 outputs the received content data to the video processor 303. When receiving a command that commands a seek from the DMC 200, the controller 302 controls the video playback speed according to the seek command. When receiving a command that commands zoom display from the DMC 200, the controller 302 controls the video display area and resolution according to the received command and causes the display unit 304 to display resulting video.

The controller 302 supplies the video processor 303 with pieces of information indicating reproducible media formats and functions that the DMR 300 accommodates (seek methods, playback speeds corresponding to each seek method, manipulations that can be accepted, etc.). These pieces of information are acquired from CMS.SinkProtocolInfo, AVT.ServiceDescription, and a response to an AVT.GetCurrent TransportAction command (mentioned above).

The video processor 303 decodes the content data that is input from the controller 302. The video processor 303 converts decoded data to a video signal having such a format as to be displayable by the display unit 304 and outputs the video signal to the display unit 304. The display unit 304 displays video using the received video signal.

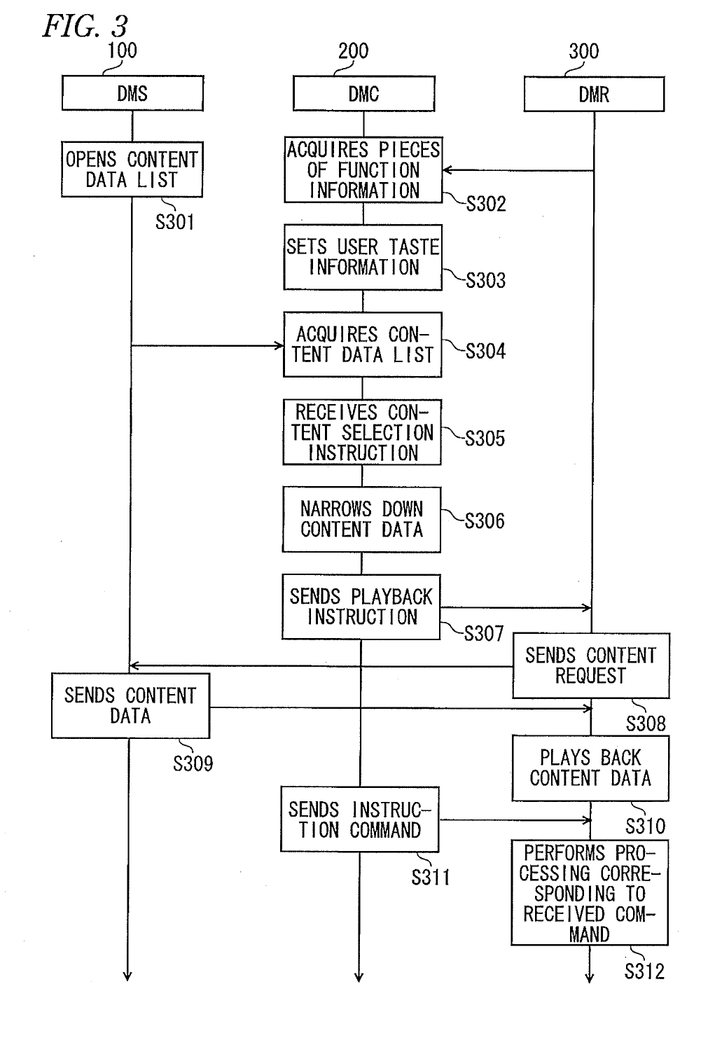

FIG. 3 illustrates operations performed by the DMS 100, the DMC 200, and the DMR 300.

First, at step S301, the DMS 100 opens a list of content data to the network using the CDS. At step S302, the DMC 200 acquires pieces of function information from the MDR 300 from, for example, CMS.SinkProtocolInfo and TransportPlaySpeed contained in AVT ServiceDescription that are sent from the DMR 300, and a response to an AVT.GetCurrentTransportAction command (mentioned above). Since the AVT.GetCurrentTransportAction command is made effective while the DMR 300 is playing back content data, the DMC 200 may collect pieces of function information by, for example, causing the DMR 300 to play back various kinds of content data and sending the above command to the DMR 300 while those content data are being played back.

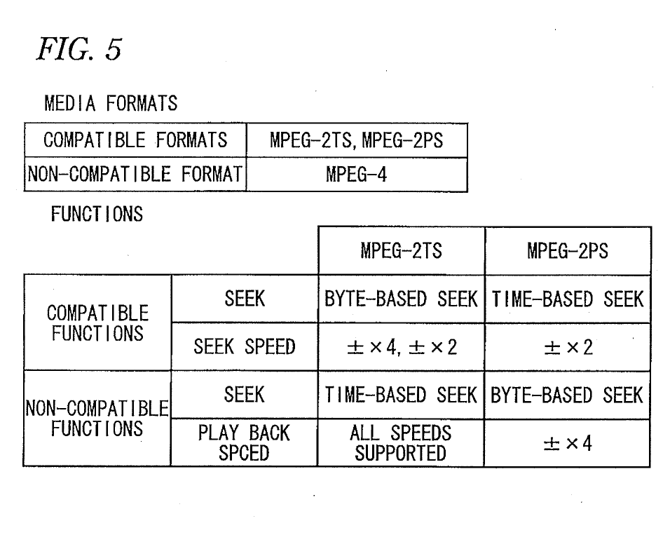

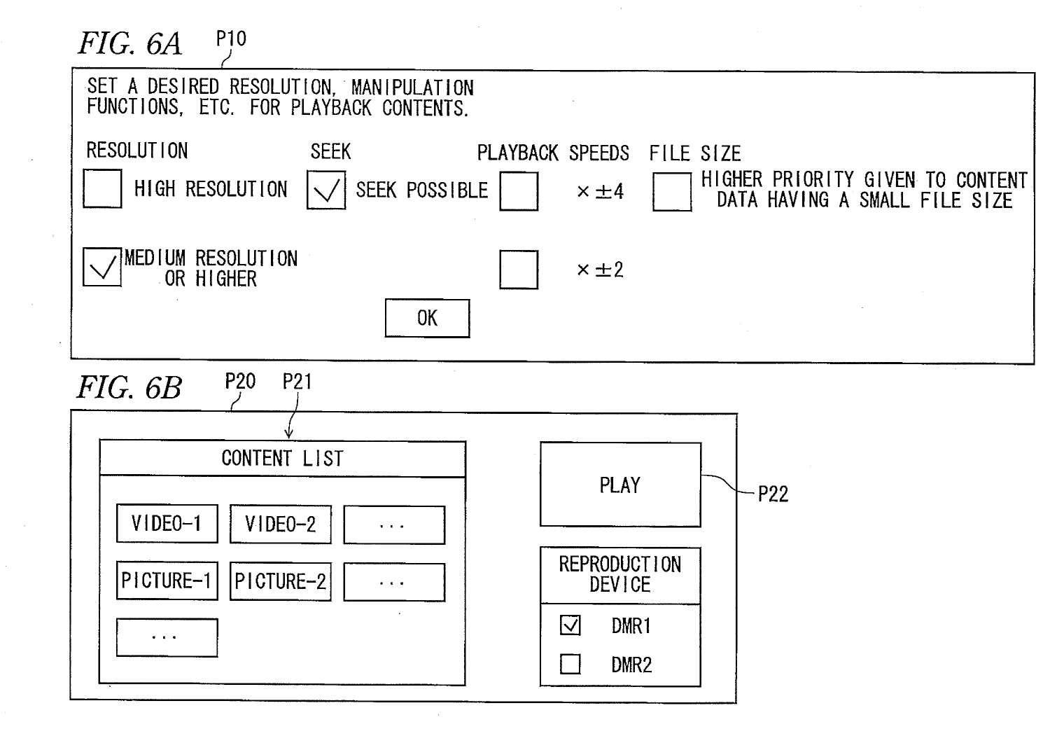

The DMC 200 generates a database of the acquired pieces of function information of the DMR 300. How to register the acquired pieces of function information will be described later with reference to FIG. 5. At step S303, the DMC 200 sets user taste information. How to set user taste information will be described later with reference to FIG. 6.

At step S304, the DMC 200 receives the list of content data that is opened by the DMS 100.

The order of execution of steps S301-S304 is not limited to the above one, and it suffices that steps S301-S304 be executed before at step S305 the DMC 200 receives a playback content selection instruction from the user.

At step S305, the DMC 200 displays a section picture which allows the user to select a playback content and receives a content selection manipulation on the section picture. If plural kinds of content data are prepared for the content to which the playback-commanding manipulation is directed, at step S306 the DMC selects one or more content data based on the user taste information (narrowing down). At step S307, the DMC 200 sends the addresses of the selected one or more content data and a playback instruction to the DMR 300.

When receiving the addresses of the selected one or more content data and the playback instruction, at step S308 the DMR 300 sends the DMS 100 a content request in which the addresses of the one or more content data are specified. When receiving the addresses of plural content data from the DMC 200, the DMR 300 selects content data that is suitable for the implementation of the DMR 300 itself and requests transmission of the selected content data.

When receiving, from the DMR 300, the content request in which the address of the content data is specified, at step S309 the DMS 100 sends the content data having the received address to the DMR 300. At step S310, the DMR 300 decodes and displays the content data.

When receiving a user manipulation relating to playback of the content data, at step S311 the MDC 200 sends an instruction command corresponding to the received manipulation to the DMR 300. Example manipulations to be received by the DMC 200 in this situation are a manipulation that commands a seek and a manipulation that commands video zoom display. At step S312, the DMR 300 controls the video playback according to the received command.

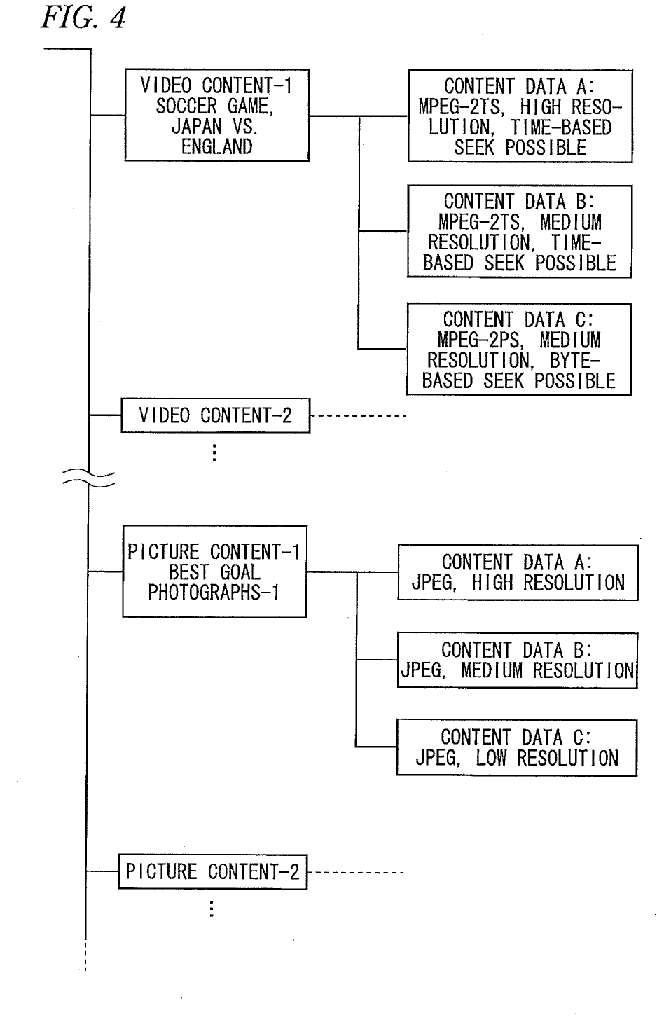

FIG. 4 illustrates a content data list to be opened by the DMS 100 and acquired by the DMC 200.

The DMS 100 stores video contents, picture (still image) contents, etc. The DMS 100 may store plural kinds of content data for the same content. For example, the DMS 100 may store content data A, B, and C for a video content-1. As for the content data A, the media format is MPEG-2TS, the resolution is high, and the possible seek method is time-based seeking. As for the content data B, the media format is MPEG-2TS, the resolution is medium, and the possible seek method is time-based seeking. As for the content data C, the media format is MPEG-2PS, the resolution is medium, and the possible seek method is byte-based seeking.

Likewise, content data A, B, and C correspond to a picture content-1. As for the content data A, the media format is JPEG and the resolution is high. As for the content data B, the media format is MEG and the resolution is medium. As for the content data C, the media format is JPEG and the resolution is low.

FIG. 5 illustrates a database, generated by the DMC 200, of pieces of information indicating functions that the DMR 300 accommodates.

The DMR 300 accommodates MPEG-2TS and MPEG-2PS but does not accommodate MPEG-4. In reproducing a MPEG-2TS content, the DMR 300 can perform a byte-based seek (playback (seek) speeds: +4, −4, +2, and −2) but cannot perform a time-based seek. In reproducing a MPEG-2PS content, the DMR 300 can perform a time-based seek (playback (seek) speeds: +2, and −2) but cannot perform a byte-based seek and does not accommodates playback speeds +4 and −4.

FIG. 6A illustrates a user taste information setting picture which is displayed by the DMC 200. The user taste information setting picture P10 includes a part which allows the user to set a desired resolution, a part which allows the user to set a desired fast feed/rewind playback speed, a part which allows the user to set whether or not he or she desires seeking, and a part which allows the user to set whether or not he or she gives higher priority to content data having a small file size. The DMC 200 sets, as user taste information, a resolution desired by the user and functions etc. relating to content reproduction that are desired by the user by receiving manipulations through the setting picture P10. More specifically, the controller 202 of the DMC 200 sets, as a judgment criterion (criteria) for selection of content data, at least one of the resolution, playback-related functions (seek method and playback speeds), file size, etc. based on a user manipulation(s).

FIG. 6B illustrates a content selection picture to be displayed by the DMC 200. The content selection picture P20 includes an image P21 showing a list of contents, an image P22 for commanding playback of a content, etc. When receiving a manipulation on one of the images indicating the respective contents in the image P21, the DMC 200 selects one or more content data that conform to the user taste information from plural kinds of content data corresponding to the thus-set content and sends addresses of the selected content data and a playback instruction to the MIR 300. The DMC 200 can select, as a DMR to play back the content data, a DMR other than the DMR 300.

When receiving a manipulation on the image P22, that is, a manipulation that commands playback of content data, the DMC 200 may display the setting picture P10 of FIG. 6A and receive instructions for setting user taste information.

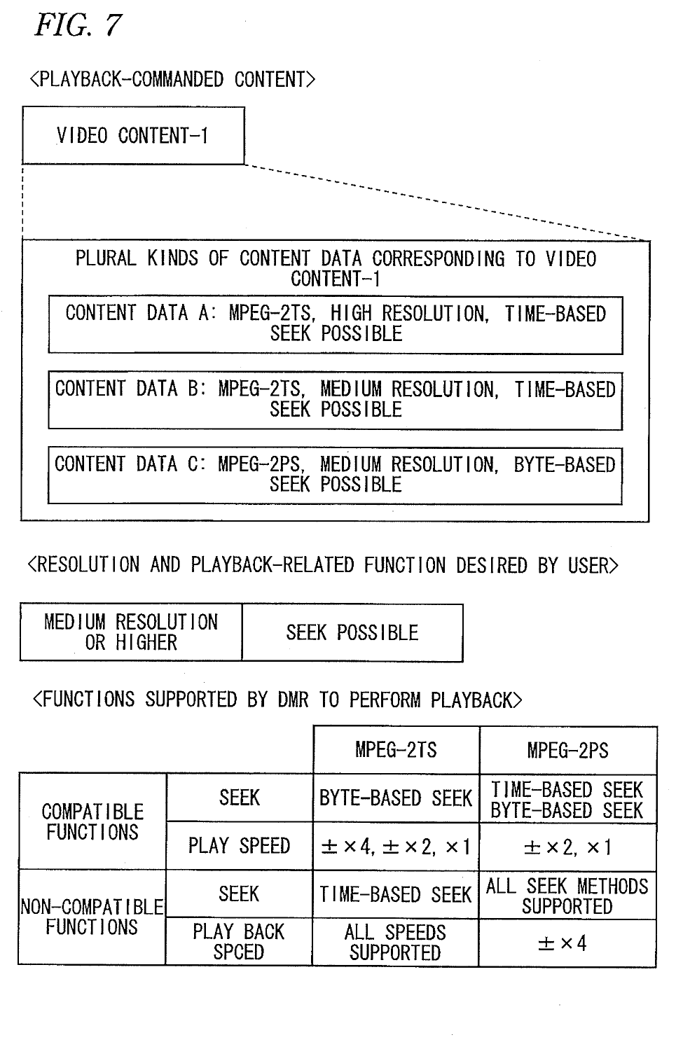

FIG. 7 illustrates an operation that when receiving a manipulation that commands playback of a content, the DMC 200 selects one content data from several kinds of content data corresponding to the playback-commanded content according to the user taste information.

Assume that the DMC 200 has received a user manipulation that commands playback of the video content-1. The plural kinds of content data A-C exist as content data corresponding to the video content-1.

Also assume that the resolution desired by the user is “medium resolution or higher” and the playback-related function desired by the user is “seeking,” and that no desired playback speeds are set.

And also assume that DMR 300 accommodates the function “byte-based seeking” for MPEG-2TS playback and the functions “time-based seeking” and “byte-based seeking” for MPEG-2PS playback.

Since the resolution desired by the user is “medium resolution or higher,” all of the content data A-C corresponding to the video content-1 satisfies the user's desire relating to the resolution. However, the DMR 300 does not accommodate time-based seeking for MPEG-2TS playback. That is, if the content data A or B is played back by the DMR 300, seeking, which is desired by the user, cannot be used.

On the other hand, the DMR 300 accommodates time-based seeking and byte-based seeking for MPEG-2PS playback and the content data C enables byte-based seeking. Therefore, in this case, the user's requirements are satisfied. Therefore, the DMC 200 selects the content data C among the content data A-C which correspond to the video content-1 and sends the address of the content data C and a playback instruction to the DMR 300.

If the DMR 300 also accommodated time-based seeking for MPEG-2TS playback, all of the content data A-C would satisfy the user's requirements. In this case, for example, the DMC 200 may narrow down the content data according to a criterion that relates to the items for which the user poses requirements. That is, since the user poses requirements for the resolution and the seeking, the DMC 200 may select, for example, content data that has a highest resolution or enables a highest playback speed among the content data A-C.

In FIG. 7, the resolution desired by the user is “medium resolution or higher” and the playback-related function desired by the user is “seeking.” On the other hand, if, for example, the user wants high resolution and does not want seeking, the DMC 200 selects the content data A. If the user wants to give higher priority to the playback speed, the DMC 200 selects the content data A preferentially. If the user wants to give higher priority to content data having a small file size, that is, content data that requires a short transfer time, the DMC 200 selects the content data B or C.

If there are plural content data that satisfies conditions required by the user, the DMC 200 may either send the DMR 300 the addresses of all the content data or send the DMR 300 the address of content data having, for example, a highest resolution (image quality), a smallest data size, or a highest playback speed.

### Second Embodiment

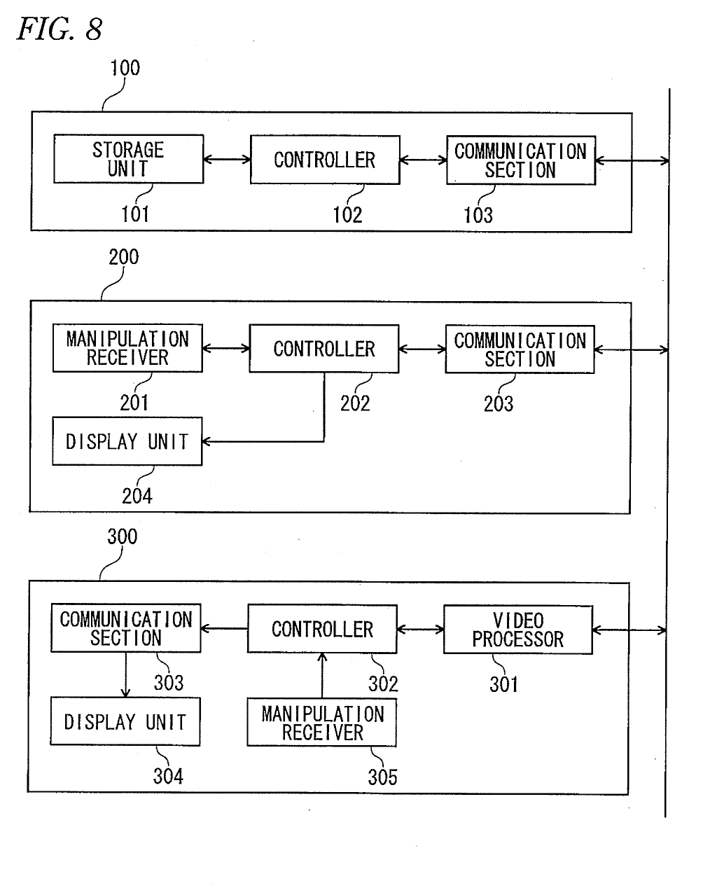

A second embodiment will be hereinafter described with reference to FIGS. 8-12.

In the second embodiment, a reproduction control device is implemented as a DMC 200 (described in the first embodiment). An example use form of this reproduction control device is basically same as the one described in the first embodiment, and the DMC 200, a DMS 100, and a DMR 300 are connected to each other by a network. In the second embodiment, the DMS 100, the DMC 200, and the DMR 300 have, in addition to the functions described in the first embodiment, a function of selecting content data that is suitable for an intended trick play (e.g., fast feed or rewind by a seek) and performing a trick play on it.

FIG. 8 illustrates system configurations of the DMS 100, the DMC 200 and the DMR 300 according to the second embodiment. The individual units and sections of each of the DMS 100, the DMC 200, and the DMR 300 have not only the same functions as described in the first embodiment but also additional functions, which will mainly be described below.

The DMS 100 includes a storage unit 101, a controller 102, a communication section 103, etc.

The storage unit 101 stores may store plural kinds of content data corresponding to the same content. Examples of such plural kinds of content data are video content data of the same broadcast program that are different from each other in the media format, resolution, bit rate, usable functions, etc.

The controller 102 assigns addresses to the respective content data stored in the storage unit 101 and generates a list in which media formats, resolutions, bit rates file sizes, and sets of usable functions (seek methods, playback speeds corresponding to each seek method, etc.) of the content data are correlated with the respective addresses and content names. The controller 102 opens the generated list to the network. When the communication section 103 receives, from the DMR 300, a content request in which an address of a content is specified, the controller 102 sends content data having the specified address to the DMR 300.

The DMC 200 includes a manipulation receiver 201, a controller 202, a communication section 203, a display unit 204, etc.

The manipulation receiver 201 receives a user manipulation. Example manipulations to be received by the manipulation receiver 201 are a manipulation for specifying a function desired by the user in playing back a content, a manipulation for selecting a content to be played back, and a manipulation as an instruction to perform a trick play (e.g., fast feed or rewind by a seek) on a content.

The controller 202 controls the individual units and sections of the DMC 200. The controller 202 acquires the list that is opened by the DMS 100 using the communication section 203. That is, the DMC 200 receives pieces of information indicating the content name, address, media format, resolution, bit rate, file size, and usable functions (seek methods, seek playback speeds, etc.) of each content data stored in the DMS 100.

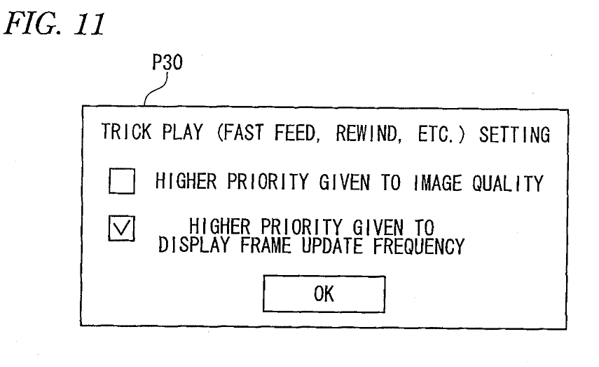

The controller 202 generates a setting picture for setting a function that is desired by the user. Example setting pictures are the setting picture described above with reference to FIG. 6A and a setting picture to be described later with reference to FIG. 11. The controller 202 displays such a setting picture on the display unit 204 and sets user taste information according to manipulations performed on the setting picture. When receiving a manipulation that commands a content playback, the controller 202 selects content data to be played back by the DMR 300 (narrowing down) from plural kinds of content data corresponding to one content based on the user taste information and the list acquired from the DMS 100. When the manipulation receiver 201 receives a manipulation that commands a trick play, the controller 202 can select content data that is suitable for the trick play. For example, the “content data suitable for the trick play” is content data for which trick plays such as fast feed and rewind can be performed and on which a trick play is performed at a high frequency of update of frames displayed by the DMR 300 or with a short response time from reception of a trick play instruction to an actual start of the trick play.

The DMR 300 includes a communication section 301, a controller 302, a video processor 303, a display unit 304, a manipulation receiver 305, etc.

The communication section 301 receives various commands and content data that are transmitted over the network. And, the communication section 301 sends various commands and notices generated by the controller 302 to the DMS 100 and the DMC 200 over the network.

The controller 302 performs processing that corresponds to a command received by the communication section 301. More specifically, when the communication section 301 receives a content address and a playback request from the DMC 200, the controller 302 sends a content request to the received address using the communication section 301. When the communication section 301 receives content data, the controller 302 outputs the received content data to the video processor 303. When receiving a command that commands a seek (trick play) from the DMC 200, the controller 302 performs a trick play such as fast feed or rewind according to the seek command.

The controller 302 communicates, to the DMC 200, pieces of information indicating functions that the DMR 300 accommodates (reproducible media formats, seek methods, playback speeds corresponding to each seek method, manipulations that can be accepted, etc.) by CMS.SinkProtocolInfo, AVT.ServiceDescription, and a response to an AVT.GetCurrentTransportAction command (mentioned above). If the video processor 303 accommodates decoding by plural codecs, the controller 302 communicates, to the DMC 200, information relating to decoding processing abilities (processing speeds) of the respective codecs.

The video processor 303 decodes the content data that is input from the controller 302. The video processor 303 converts decoded data to a video signal having such a format as to be displayable by the display unit 304 and outputs the video signal to the display unit 304. The display unit 304 displays video using the received video signal.

The manipulation receiver 305 receives a manipulation that is made by the user through the setting picture shown in FIG. 11 (described later), for example, and outputs information of the received manipulation to the controller 302.

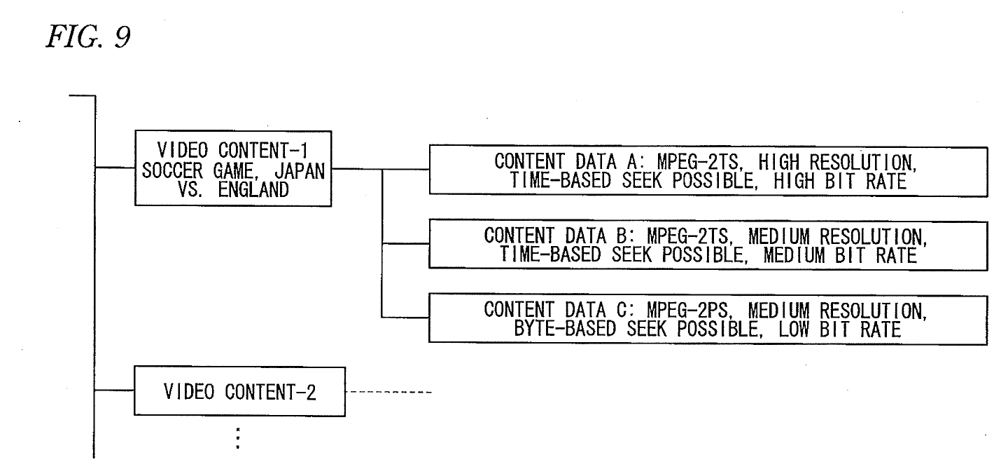

FIG. 9 illustrates a content data list to be opened by the DMS 100 and acquired by the DMC 200 in the second embodiment.

The DMS 100 may store plural kinds of content data for the same content. For example, the DMS 100 stores content data A, B, and C for a video content-1. As for the content data A, the media format is MPEG-2TS, the resolution is high, the possible seek method is time-based seeking, and the bit rate is high (e.g., 25 Mbps). As for the content data B, the media format is MPEG-2TS, the resolution is medium, the possible seek method is time-based seeking, and the bit rate is medium (e.g., 10 Mbps). As for the content data C, the media format is MPEG-2PS, the resolution is medium, the possible seek method is byte-based seeking, and the bit rate is low (e.g., 3 to 4 Mbps).

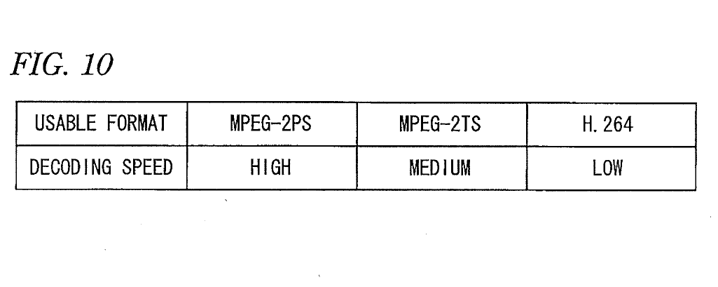

FIG. 10 illustrates a database, generated by the DMC 200, of pieces of decoding processing ability information of the DMR 300. For example, the DMR 300 accommodates MPEG-2PS, MPEG-2TS, and H.264 the decoding speeds for which are high, medium, and low, respectively.

FIG. 11 illustrates an example user taste information setting picture P30 which is displayed by the DMC 200. The user taste information setting picture P30 is a picture through which to set which of the image quality (at least one of the resolution and the bit rate) and the display frame update frequency higher priority should be given to in track plays such as fast feed and rewind. The DMC 200 determines which of the image quality and the display frame update frequency higher priority should be given to in trick plays by receiving a manipulation through the setting picture P30. Although not shown in FIG. 11, user taste information may be set by displaying the user taste information setting picture P10 described in the first embodiment.

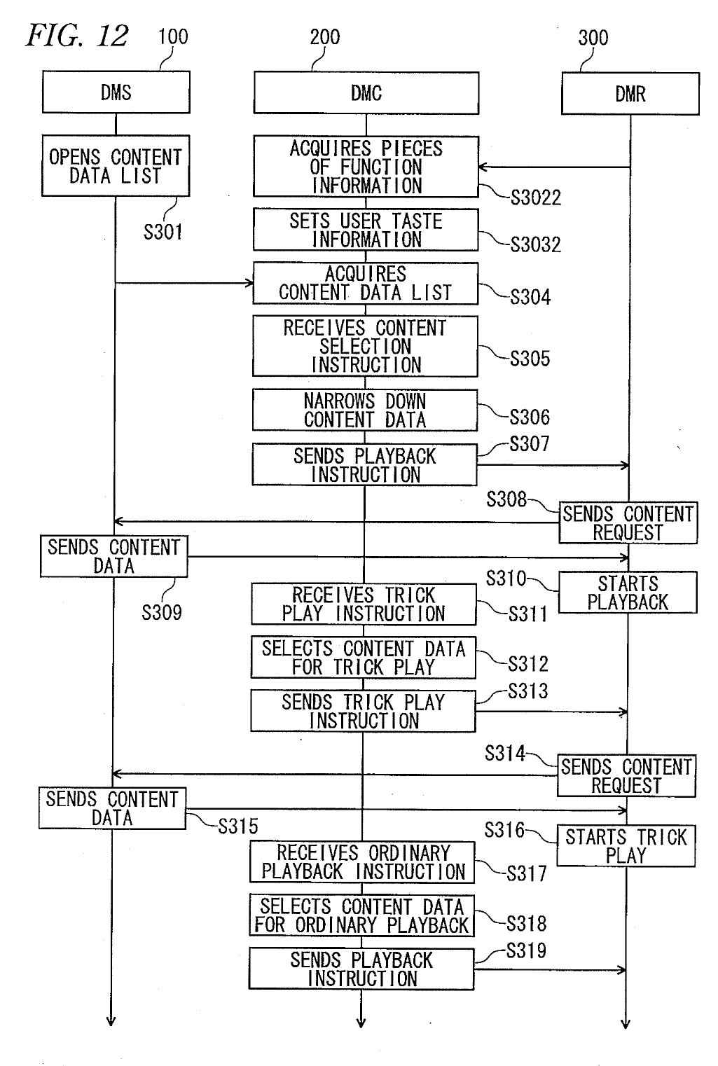

FIG. 12 illustrates operations performed by the DMS 100, the DMC 200, and the DMR 300 in the second embodiment. This sequence diagram includes the same steps as the sequence diagram of the first embodiment shown in FIG. 3, and steps that are different than in the first embodiment will mainly be described below.

First, at step S301, the DMS 100 opens a list of content data to the network. At step S3022, the DMC 200 acquires pieces of function information from the DMR 300. In the second embodiment, the pieces of function information include information relating to the decoding abilities of the DMR 300 corresponding to the respective codecs. The DMC 200 generates a database based on the acquired pieces of function information of the DMR 300. For example, the database is generated in the form shown in FIGS. 5 and 10. At step S3032, the DMC 200 displays the user taste information setting picture on the display unit 204 and sets user taste information according to manipulations performed on the setting picture. In the second embodiment, the user taste information includes a setting relating to content data to be selected at the time of a trick play.

At step S304, the DMC 200 receives the list of content data that is opened by the DMS 100. The order of execution of steps S301, S3022, S3032, and S304 is not limited to the above, and it suffices that steps S301, S3022, S3032, and S304 be executed before the DMC 200 receives a playback content selection instruction from the user at step S305.

At step S305, the DMC 200 displays the selection picture which allows the user to select a playback content and receives a content selection manipulation on the selection picture. If plural kinds of content data are prepared for the content to which the playback-commanding manipulation is directed, at step S306 the DMC selects one or more content data based on the user taste information (narrowing down) in the same manner as described in the first embodiment. At step S307, the DMC 200 sends the address(es) of the selected one or more content data and a playback instruction to the DMR 300. This playback instruction is an instruction to perform an ordinary playback of the +1 speed.

When receiving the address(es) of the selected one or more content data and the playback instruction, at step S308 the DMR 300 sends the DMS 100 a content request in which the address(es) of the one or more content data are specified. When receiving the addresses of plural content data from the DMC 200, the DMR 300 selects content data that is suitable for the implementation of the DMR 300 itself from the plural content data and requests transmission of the selected content data.

When receiving, from the DMR 300, the content request in which the address of the content data is specified, at step S309 the DMS 100 sends the content data having the received address to the DMR 300. At step S310, the DMR 300 decodes and displays the received content data.

When receiving, at step S311, a manipulation as an instruction to perform a trick play on the content data being played back ordinarily, at step S312 the DMC 200 selects content data that is suitable for the trick play. For example, the “content data suitable for the trick play” is content data for which trick plays such as fast feed and rewind can be performed and on which a trick play is performed at a high frequency of update of frames displayed by the DMR 300.

When the network bandwidth is restricted or decoding processing by the DMR 300 takes long time, the frequency of update of frames displayed by the DMR 300 at the time of a trick play may vary depending on the resolution, the bit rate, and the codec used of content data. More specifically, whereas the frame update frequency may be three times per second, for example, when a trick play is performed on content data having a low resolution or bit rate, the frame update frequency may be 0.5 time per second, for example, when a trick play is performed on content data having a high resolution or bit rate.

In view of the above, at step S3032, the DMC 200 causes the user to select one of the image quality and the frame update frequency as an item to which higher priority should be given at the time of a trick play. If higher priority should be given to the frame update frequency, at step S312 the DMC 200 selects content data that will cause a higher frame update frequency among the plural kinds of content data corresponding to the same content. The parameters relating to the frame update frequency are the resolution, bit rate, codec, etc. The frame update frequency increases as the resolution or the bit rate becomes lower. Therefore, if higher priority should be given to the frame update frequency, the DMC 200 selects content data having a lower resolution or bit rate. The DMC 200 may select content data at least one of whose resolution and bit rate is lower than a prescribed value. Or the DMC 200 may select content data at least one of whose resolution and bit rate is lowest among the plural content data corresponding to the same content.

There may occur a case that the user wants to give higher priority to the frame update frequency but desires image quality that is higher than a prescribed level. In view of this, the DMC 200 may set a lowest user-permissible level for the image quality (at least one of the resolution and the bit rate) and select content data that will cause a highest frame update frequency among content data whose image quality is higher than the lowest user-permissible level.

The decoding processing ability of the DMR 300 may vary depending on the codec. In view of this, the DMC 200 acquires information of decoding processing abilities of the DMR 300 at step S3022. If higher priority should be given to the frame update frequency, the DMC 200 selects content data corresponding to a codec having a higher decoding processing ability in the DMR 300 based on the information of decoding processing abilities of the DMR 300.

At step S313, the DMC 200 sends, to the DMR 300, a seek command (trick play instruction) containing an address of the selected content data. When receiving the address of the content data and the trick play instruction, at step S314 the DMR 300 sends, to the DMS 100, a content request in which the content data address is specified. During a trick play, for example, the DMR 300 successively sends, to the DMS 100, content requests in each of which a position that succeeds or precedes the current payback position by a prescribed time.

When receiving, from the DMR 300, the content request in which the content data address is specified, at step S315 the DMS 100 sends content data corresponding to the received address to the DMR 300. At step S316, the DMR 300 decodes and displays the received content data. The DMR 300 performs s trick play such as fast feed or rewind by successively receiving and playing back content data whose position succeeds or precedes the current payback position by the prescribed time.

When receiving, at step S317, a manipulation as an instruction to return to an ordinary playback, at step S318 the DMC 200 again selects the content data that was or were selected at step S306. At step S319, the DMC 200 sends the address(es) of the content data and a playback instruction to the DMR 300. If the DMC 200 selected the plural content data at step S306, at step S318 the DMC 200 may either select the plural content data again or select the one content data that was played back by the DMR 300 at step S310.

After the DMC 200 sends the playback instruction at step S319, the DMR 300 acquires and plays back the content data according to the received playback instruction.

In the first embodiment, if a prescribed playback speed (e.g., quadruple speed or double speed) is registered as part of user taste information, the DMC 200 selects content data that enables use of the registered playback speed at step S306 (content data narrowing down). On the other hand, in the second embodiment, at step S306 the DMC 200 may select content data that does not enable use of a playback speed that is registered as part of user taste information because in causing a trick play the DMC 200 can switch to content data that is different from content data to be played back ordinarily. For example, if a trick play request is received after selection of content data that enables an ordinary playback of only the normal speed, the DMC 200 may select content data that enables the requested trick play.

In the sequence diagram of FIG. 12, the DMC 200 selects content data that is suitable for a trick play. An alternative configuration is possible in which the DMR 300 selects content data that is suitable for a trick play. That is, at step S312, instead of the controller 202 of the DMC 200, the controller 302 of the DMR 300 selects content data. The DMR 300 may display the setting picture shown in FIG. 11 on the display unit 304, receive a manipulation on the setting picture through the manipulation receiver 305, and switch between the image quality priority setting and the frame update frequency priority setting according to the received manipulation.

Although the embodiments have been described above, these embodiments are only represented as examples, and should not limit the scope of the invention. These embodiments may be variously implemented with omissions, replacements, and/or changes and/or modifications, within the spirit and scope of the invention. These embodiments and such modifications will fall within the scope of Claims and its equivalents.

1. A reproduction control device comprising:
a first receiving module configured to receive addresses of content data stored in a storage device connected to a network, wherein the content data comprise usable functions and first function information that indicate sets of usable functions of the content data, and wherein the content data correspond to each other in substance but are different from each other in the usable functions and the first function information;
a second receiving module configured to receive second function information that indicate functions supported by an external device;
a selecting module configured to select a function to be used in playing back; and
a sending module configured to determine whether there are one or more content data among the content data that allow the external device to use the selected function according to the received first function information and the second function information, and, if there are, to send an address of the determined one or more content data to the external device.

2. The reproduction control device of claim 1,
wherein the first receiving module is configured to receive, as the first function information, information that indicates whether each of the content data enables use of a seek function,
wherein the second receiving module is configured to receive, as the second function information, information that indicates whether the external device accommodates the seek function, and
wherein the sending module is configured to determine one or more content data that allow the external device to use the seek function among the content data and to send an address of the determined one or more content data to the external device.

3. The reproduction control device of claim 2,
wherein the first receiving module is configured to receive, as the first function information, information relating to at least one of resolutions and bit rates of the content data, and
wherein, in causing the external device to perform a trick play that uses a seek function, the sending module is configured to send, to the external device, an address of content data selected based on at least one of the resolutions and the bit rates among the content data.

4. The reproduction control device of claim 3,
wherein, in causing the external device to perform the trick play, the sending module is configured to send, to the external device, an address of content data at least one of a resolution or a bit rate of which is lower than a value among the content data.

5. The reproduction control device of claim 3,
wherein the first function information relates to coding formats of the content data,
wherein the second function information relates to decoding abilities of respective coding formats of the external device, and
wherein, in causing the external device to perform the trick play, the sending module is configured to send, to the external device, an address of content data having a coding format for which a decoding ability of the external device is high among the content data.

6. The reproduction control device of claim 3,
wherein the selecting module is configured to make a selection as to which of a frequency of update of frames to be displayed by the trick play and image quality of the frames to be displayed by the trick play higher priority should be given to, and
wherein, if the selecting module selects that higher priority should be given to the frequency of update, in causing the external device to perform the trick play, the sending module is configured to send, to the external device, the address of the content data selected based on the at least one of the resolutions and the bit rates among the content data.

7. The reproduction control device of claim 2,
wherein the first receiving module is configured to receive, as the first function information, information indicating one of plural seek functions of different methods that are usable with each of the content data stored in the storage device,
wherein the second receiving module is configured to receive, as the second function information, information indicating a seek function supported by the external device among the plural seek functions, and
wherein the sending module is configured to determine one or more content data that allow the external device to use a seek function among the content data, and to send an address of the determined one or more content data to the external device.

8. The reproduction control device of claim 2,
wherein the first receiving module further is configured to receive resolution information indicating resolutions of the content data stored in the storage device, and
wherein the sending module is configured to determine one or more content data that allow the external device to use the seek function and have a resolution that is higher than or equal to a prescribed resolution among the content data, and to send an address of the determined one or more content data to the external device.

9. The reproduction control device of claim 2,
wherein the first receiving module further is configured to receive data size information indicating data sizes of the content data stored in the storage device, and
wherein the sending module is configured to determine one or more content data that allow the external device to use the seek function and have a data size that is smaller than or equal to a size among the content data, and to send an address of the determined one or more content data to the external device.

10. The reproduction control device of claim 2,
wherein the first receiving module further is configured to receive resolution information indicating resolutions of the content data stored in the storage device, and
wherein the sending module is configured to determine content data that allows the external device to use the seek function and has a highest resolution that is higher than or equal to a prescribed resolution among the content data, and to send an address of the determined content data to the external device.

11. The reproduction control device of claim 2,
wherein the first receiving module further is configured to receive data size information indicating data sizes of the content data stored in the storage device, and
wherein the sending module is configured to determine content data that allows the external device to use the seek function and has a smallest data size among the content data, and to send an address of the determined content data to the external device,

12. The reproduction control device of claim 2,
wherein the first receiving module further is configured to receive seek speed information indicating seek speeds of the content data stored in the storage device, and
wherein the sending module is configured to determine content data that allows the external device to use the seek function and has a highest seek speed among the content data, and to send an address of the determined content data to the external device.

13. The reproduction control device of claim 1,
wherein the sending module is configured to send the address of the one or more content data and a playback instruction to the external device.

14. A reproduction control method of a reproduction control device comprising:
receiving addresses of content data stored in a storage device connected to a network, wherein the content data comprise usable functions and first function information that indicate sets of usable functions of the content data, and wherein the content data correspond to each other in substance but are different from each other in the usable functions and the first function information;
receiving second function information that indicate functions supported by an external device;
selecting a function to be used in playing back; and
determining whether there are one or more content data that allow the external device to use the selected function among the content data according to the received first function information and the second function information, and when there are, sending an address of the determined one or more content data to the external device.
